(19) United States
(12) Patent Application Publication
(10) Pub. No.: US 2003/0015282 A1
(43) Pub. Date: Jan. 23, 2003

(54) Floor covering

(76) Inventors: Raymond Joseph Reisdorf, Nobressart (BE); Loic Pierre Rolland, Vesenex (FR)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/158,549

(22) Filed: May 30, 2002

(30) Foreign Application Priority Data
May 30, 2001 (GB) 0113109.3

(51) Int. Cl. B32B 31/00

(52) U.S. Cl. 156/244.11; 428/292.1

(57) ABSTRACT

A floor covering is described having a point-bonded nonwoven upper fabric layer and at least one backing layer. The floor covering has excellent abrasion and wear resistance. An antistatic floor covering comprising a point-bonded nonwoven upper fabric layer is also described.

### CROSS REFERENCE TO RELATED APPLICATION

This application claims the benefit of UK Patent Application No. 0113109.3, filed May 30, 2001.

### BACKGROUND OF THE INVENTION

1. Field of the Invention

This invention relates to a floor covering. More particularly, this invention relates to a lightweight non-woven floor covering having improved abrasion resistance, no edge fraying and improved wear resistance.

2. Description of Related Art

Non-woven materials are well known. They consist of a manufactured sheet, web or batt of directionally oriented or randomly oriented fibers bonded by various techniques. The fibers may be of natural or man-made origin. However, the fibers used nowadays are usually synthetic. Synthetic non-woven materials are attractive from a commercial point of view, since they can be produced very economically.

Non-woven materials can have various properties, depending on the bonding method and types of fiber used. For example, non-woven materials have applications ranging from baby diapers to high performance textiles.

One application of non-woven materials is in the manufacture of floor coverings. Non-woven needle-piled carpets have been produced in the past from a needle-punching and thermal bonding process. In the needle-punching process, a fibrous web material is subjected to the reciprocating action of barbed needles which repeatedly penetrate the web so that the material becomes matted.

A number of methods of producing thermally bonding non-woven materials exist. These include hot calendering (including area bonding and point-bonding), belt calendering, oven bonding, ultrasonic bonding and radiant heat bonding.

To date, the use of non-woven materials in the upper fabric layer of floor coverings has generally been limited to oven bonded needle-pile fabrics. These fabrics are produced by needle-punching a fibrous batt of non-woven material and then oven-bonding the needle-punched material using a flow of hot air or steam which melts the fibers. Upon cooling, firm bonds are formed at all points of fiber contact. This method of thermal bonding is described in, for example, U.S. Pat. No. 4,068,036.

In addition, non-woven materials have been used to a much greater extent in the manufacture of stabilizing layers for floor coverings. The spun-bonded fabric, Typar® is an example of a non-woven material which has been used in producing carpet stabilizing layers. However, this invention is concerned with materials used for the upper fabric layer of floor coverings. Accordingly, as used hereinafter, the term non-woven floor covering refers to a non-woven upper fabric layer of a floor covering.

In addition to the bonding method employed, the properties of non-woven materials are also dependent on the types of fiber. Commonly used fibers are derived from polyesters, polyolefins, regenerated cellulose-based fibers (such as rayon) and polyamides (such as nylons). A fiber may be a monocomponent fiber or a bicomponent fiber. Bicomponent fibers are made by extruding two polymers from the same spinneret with both polymers being contained within the same filament. Bicomponent fibers are classified as “side-by-side” or “sheath-core” fibers. Non-woven floor coverings have been made previously from thermally oven bonded sheath-core bicomponent fibers. The sheath polymer is chosen such that it has a lower melting point than the core polymer. When a batt of bicomponent fibers is heated, the sheath polymer melts and provides bonding between contiguous fibers on cooling. Heterofil is a well-known example of a sheath-core bicomponent fiber. Heterofil has a nylon 6,6 core polymer and a nylon 6 sheath polymer. It has been used in the past to produce needle-piled non-woven floor coverings by an oven bonding method.

A problem with the non-woven floor coverings of the prior art is that they have unacceptable abrasion- and wear-resistance over a prolonged period of time. A further problem with needle-pile non-woven floor coverings is that they are difficult to print.

Accordingly, it is an object of the present invention to provide a floor covering comprising a lightweight non-woven upper fabric layer which has the desirable qualities of exceptional abrasion- and wear-resistance.

It is a further object of the present invention to provide a floor covering with an upper fabric layer having edge-fray resistance.

It is yet a further object of the present invention to provide a floor covering having an upper fabric layer which is printable and also has pleasing aesthetic and tactile qualities, often referred to as the “hand” of the fabric. The combination of pleasing aesthetic qualities and exceptional wear-resistance means that it is a further object of this invention to provide an attractive alternative to hard, vinyl floor coverings known in the prior art.

### BRIEF SUMMARY OF THE INVENTION

Accordingly, the present invention provides a floor covering, comprising a non-woven upper fabric layer and at least one backing layer characterized in that said nonwoven fabric is a point-bonded fabric.

As used herein, the term “floor covering” means any material used for covering a floor. Such materials are commonly referred to as carpets or carpet tiles, although the floor coverings of the present invention would be more accurately described in the art as textile sheets.

Point bonding is a method of thermally bonding non-wovens using a hot calendar. The method involves the use of a two-roll nip consisting of a first heated male patterned metal roll and a second smooth or patterned metal roll. The second roll may or may not be heated. Nip refers to the line of near contact between two calendars through which material passes. In a typical production line, a fibrous web is fed to the calender nip and the fiber temperature raised to a point at which melting causes contiguous fibers caught between the two calendars to adhere together. Patterned points on one of the rolls impart an imprinted pattern on the resultant fabric and govern the points at which thermal bonding occurs. A point-bonding, method employing a bicomponent fiber is described in UK Patent 1,245,088. In the point-bonding method, the fibrous material may be subjected to needle-punching prior to point-bonding.

In one aspect of the present invention, there is provided a floor covering as hereinbefore described wherein the thermally point-bonded fabric layer is produced by a process comprising the steps of:

(a) providing a fibrous web of synthetic fibers;

(b) needle-punching said fibrous web to provide a needle-punched material; and

(c) thermally point-bonding said needle-punched material.

Point-bonded non-woven materials have been used previously in, for example, diaper and sanitary products. These materials have also been used advantageously and with commercial success in shoe linings, since they can absorb a large amount of water and are quick drying.

However, point-bonded non-woven materials have not been used before in the manufacture of floor coverings, despite their known use in other applications. The present inventors have found that point-bonded non-woven materials are particularly well-suited to the demands of a high performance floor covering, as evidenced by a number of standard test procedures used to assess and evaluate new carpet materials. It has now been found that point-bonded non-woven materials perform excellently in these tests, making them ideally suited for a new generation of high performance floor coverings.

The floor covering of the present invention comprises at least one backing material affixed to the underside of the fabric layer. The nonwoven upper fabric layer is affixed to the backing layer by extruding a molten thermoplastic polymer adhesive layer onto both the underside of the nonwoven fabric and one side of the backing layer at substantially the same time as said nonwoven fabric and backing layer enter a nip, and then compressing said nonwoven upper fabric layer, said molten polymer adhesive layer, and said backing layer in said nip. Suitable backing materials are well known in the art. Preferably, the floor covering of the present invention comprises 2 to 4 layers, that is 1 to 3 backing layers. The backing layer(s) may be selected from a cushioning layer, a stabilizing layer, a fleece underlayer or a combination of two or more of these.

### DETAILED DESCRIPTION OF THE INVENTION

In a first embodiment, the floor covering comprises two layers wherein the upper fabric layer is affixed to a cushioning layer. The cushioning layer is attached to the underside of the fabric layer by a suitable adhesive means which may be permanent or releasable. Examples of such adhesives include aqueous or non-aqueous latex adhesives, thermoplastic adhesives and hot-melt adhesives. Suitable aqueous latex adhesives include, for example, styrene-acrylate copolymers, styrene-butadiene copolymers, ethylene/vinyl acetate copolymers, polyacrylates and blends thereof. Suitable thermoplastic adhesives include, for example, polyurethanes, polyolefins, ethylene/vinyl ester copolymers, ethylene/alkyl (meth)acrylate copolymers, ethylene/olefin copolymers and polyvinyl chlorides. Suitable hot-melt adhesives include, for example, adhesives comprising a thermoplastic resin, tackifying resins, waxes and plasticizers as described in U.S. Pat. Nos. 4,939,036 and 4,844,765. Thermoplastic and hot-melt adhesives in the form of films may be used. The cushioning layer and/or the fabric layer may be coated with the adhesive in any manner such as spraying, dipping, kiss-roll coating or by lamination. Other means for attaching the cushioning layer to the fabric layer include pressure-sensitive adhesives, mechanical means, such as a Velcro® hook and loop fastening system and ultrasonic bonding.

The thermoplastic polymer adhesive of the process of the invention is preferably a resin comprising an ethylene copolymer of from 50 to 95 weight % ethylene and 5 to 50 weight % of one or more comonomers selected from the group consisting of vinyl esters, α,β unsaturated carboxylic acids, α,β unsaturated carboxylic acid esters, and mixtures thereof. The ethylene copolymer adhesive typically will involve comonomers of from three to about ten carbons with ethylene/vinyl acetate being preferred. It should also be appreciated that small amounts of other α,β unsaturated olefins can also be present as comonomers as generally known in the art. Examples of ester comonomers are vinyl acetate, butyl acrylate or methyl acrylate. Examples of desired acids are methacrylic acid or acrylic acid. The polymer adhesive used in the process of the invention may also comprise blends of such ethylene copolymers and terpolymers. More preferably, the adhesive is a terpolymer containing 50-98 weight % ethylene, 1-25 weight % butyl acrylate and 1-25 weight % methacrylic acid or a copolymer containing 80-99 weight % ethylene and 1-20 weight % methacrylic acid. The most preferred adhesive is from the family of terpolymers containing 60-90 weight % ethylene, 5-20 weight % butyl acrylate and 5-20 weight % methacrylic acid. For these copolymers and terpolymers, a melt flow index (MFI) of between 1 and 50 is preferred and an MFI of 20 to 40 is more preferred.

In a preferred embodiment, the nonwoven upper fabric layer is affixed to the backing layer by extruding a molten thermoplastic polymer adhesive layer onto both the underside of the nonwoven fabric and one side of the backing layer at substantially the same time as said nonwoven fabric and backing layer enter a nip, said thermoplastic polymer adhesive layer consisting of a resin from the group of ethylene copolymers and terpolymers comprising 50-95 weight % ethylene and 5-50 weight % of one or more comonomers selected from esters and/or carboxylic acids, and then compressing said nonwoven upper fabric layer, said molten polymer adhesive layer, and said backing layer in said nip.

The cushioning layer may comprise any suitable material such as a foamed composition of rubber, latex, hot-melt resins, urethane resins or polyvinyl chloride resins. The thickness of the cushioning layer is typically from 1 to 15 millimeters, preferably 3 to 10 millimeters.

The cushioning layer may also be a carpet comprising a primary backing laminated to a secondary backing material with tufts of yarn projecting from the primary backing. These and other types of suitable cushioning layers are described in, for example, U.S. Pat. No. 5,965,232. Alternatively, the cushioning layer may be a fleece.

In a second embodiment, there is provided a stabilizing layer in addition to the cushioning layer. In this embodiment, the stabilizing layer is attached to the underside of the fabric layer, and the cushioning layer attached to the underside of the stabilizing layer. The above-mentioned adhesives may be used for bonding each layer to its adjacent layer(s).

A stabilizing layer promotes better adhesion between the fabric layer and the cushioning layer. Further, the stabilizing layer also provides resistance against punctures to the fabric layer and reduces the degree of indentation marks when furniture legs and the like are placed on the floor covering. The stabilizing layer is typically a glass fiber scrim or sheet material, the thickness of which ranges from 0.05 to 6 millimeters. Suitable materials for the stabilizing layer are described in U.S. Pat. No. 5,965,232.

In another embodiment, there is provided a floor covering as described in the first or second embodiments hereinabove, with an additional fleece underlayer attached to the underside of the cushioning layer. The additional fleece underlayer may be attached to the cushioning layer using any suitable adhesive, such as those described hereinabove. The additional fleece underlayer facilitates installation of a floor covering of the present invention by Velcro® attachment.

Preferably, the upper fabric layer is coated with a polymeric coating. Such coatings include “stain resist” coatings which provide resistance to staining by acid dyes. Suitable stain resist agents include, for example, sulfonated phenol- or naphthol-formaldehyde condensate products, hydrolyzed vinyl aromatic-maleic anhydride polymers, partially sulfonated novolak resin and polymethacrylic acid, as described in U.S. Pat. Nos. 4,925,707 and 4,822,373. In addition, “soil-resist” agents may be coated onto the fabric layer. These include, for example, fluorochemical compositions described in U.S. Pat. No. 4,643,930. “Water-repellent” agents such as the fluorochemical, silicone and acrylic compositions described in U.S. Pat. No. 4,348,785 may also be used. These polymeric coatings may, optionally, be used alone or in combination. They may also contain other additives such as antimicrobial agents, UV stabilizers, antioxidants and fillers.

Preferably, the top surface of the upper fabric layer is coated with the polymeric coating. However, the bottom surface of the fabric layer may also be coated with the polymeric coating as described hereinabove, for example, to improve water repellency.

The polymeric coatings may be applied by known techniques including extrusion, spraying, foaming, dipping, knife coating, transfer-coating or lamination. In some instances, the polymeric coating may be subsequently cured by thermal heating, UV light or fusion.

The upper fabric layer may be printed. In general, printing involves applying colouring agents onto the fabric which is then treated with heat or chemicals to fix the colouring agents. Printing techniques include, for example, pigment printing, roller printing, screen printing and heat transfer printing.

Preferably, the upper fabric layer has an area weight of from 60 to 300 grams/meter². More preferably, the fabric layer has an area weight of from 80 to 200 grams/meter², more preferably 150 to 180 grams/meter².

Preferably, the upper fabric layer has a thickness of from 0.2 to 2.0 millimeters. More preferably, the fabric layer has a thickness of from 0.4 to 1.2 millimeters, more preferably 0.7 to 1.0 millimeter.

The point-bonded upper fabric layer used in the present invention is made from synthetic fibers, which may be either monocomponent or bicomponent fibers. Preferably, the fabric layer is made from bicomponent fibers, which are usually more versatile than monocomponent fibers. The bicomponent fibers may be polymeric side-by-side or sheath-core fibers, or a mixture thereof. Preferably, the bicomponent fiber is a sheath-core fiber. Examples of polymers suitable for use in bicomponent fibers are poly(ethylene terephthalate), polyethylene, polystyrene, acetal polyurethane and nylons. Preferably, the bicomponent fiber of the present invention has a core of nylon 6,6 and a sheath of nylon 6. In this preferred embodiment, the sheath has a melting point of about 220° C., while the core has a melting point of about 260° C. Such bicomponent fibers are well known in the art, usually termed Heterofil fibers.

One disadvantage of nylon-based floor coverings is that they tend to give rise to static electricity. Static electricity is generated on carpets by the rubbing action of shoe heels and soles, when both the carpet and the person receive a charge. This build up of charge can result in a potentially painful shock when the person touches an earthed object.

Accordingly, in one embodiment of the present invention, there is provided a floor covering as described hereinabove wherein the fabric layer is suitably conductive, preferably having a conductivity in the range of 10⁵-10¹⁰ ohms. In this embodiment, an amount of conductive fibers is preferably used in addition to the fibers described hereinabove when manufacturing the fabric layer. The conductive fibers may be manufactured by adding a suitable antistatic agent to the extruder during production of the fibers. Preferably, the antistatic agent added is carbon black, which gives the fibers suitable conductivity.

Preferably, in this embodiment, the backing layer(s) will also be conductive, providing antistatic properties. Suitable conductive backing layers are well known in the art and typically contain an amount of carbon black. Alternatively, the backing layers may contain Tallopol® or Elactiv® latex additives. Preferably, in this embodiment, the polymeric coating(s) optionally applied to the fabric layer will be selected to have suitable antistatic properties. An example of a suitable antistatic coating is Teflon®.

The present invention further provides a conductive point-bonded non-woven fabric suitable for use in antistatic floor coverings.

This invention further provides the use of a point-bonded non-woven fabric as described hereinabove in the manufacture of a floor covering.

This invention further provides a method of producing a floor covering comprising the steps of providing a point-bonded non-woven fabric as hereinbefore described and affixing said non-woven fabric to at least one backing layer. The backing layer(s) may be selected from a cushioning layer, a stabilizing layer, a fleece underlayer or a combination of two or more of these. Examples of suitable backing layers are described hereinabove. The backing layer(s) may be affixed to the upper fabric layer using, for example, any of the adhesive means described hereinabove.

The present invention will now be described with reference to the following examples. It will be appreciated that the invention is described by way of example only and that modifications of detail may be made without departing from the scope of the invention.

### EXAMPLES

Preparation I (Point-Bonded Nonwoven Fabric)

A web of randomly laid nylon heterofil fibers (65 millimeters in length) was passed through a thermal point bonding calendar at a calendar roll speed of 7.6 meters/minute. The upper roll of the calendar was engraved with a pique pattern, the lower roll was plain. The bond area of the patterned roll was 13% with bond point dimensions of 2.5 millimeters long by 0.35 millimeter wide. The surface temperature of the upper patterned roll was 215° C. and the surface temperature of the lower plain roll was 205° C. The nip force between the two rolls was 48 Newtons/millimeter. The point-bonded fabric thus obtained had an area weight of 180 grams/meter².

Preparation 2 (Area-Bonded Nonwoven Fabric)

A web of randomly laid nylon heterofil fibers (50 millimeters in length) was subjected to needling, consisting of tacking followed by both up and down punching and a further up-punching stage using forked needles to produce a ribbed effect. The punched web was area-bonded by passing it through a 3-4 meter oven heated to 200-250° C. at a speed of 1.5-3.0 meters/minute. The resultant fabric had an area weight of 265 grams/meter².

### Example 1

The point-bonded nonwoven fabric prepared above was bonded to an 80% polypropylene/20% polyester fleece by extrusion lamination. The fleece had an area weight of about 550 grams/meter² and had a thickness of about 3.5 millimeters. The polymer was a thermoplastic polymer consisting of an acid-modified ethylene acrylate. It was extruded into a thin film, transferred to a surface of the fleece and the nonwoven fabric held in contact with the coated fleece on opposing rollers. Upon cooling, the polymer laminates the nonwoven fabric to the fleece.

### Example 2

Example 1 was repeated using a polyester hot melt polymer to laminate the nonwoven fabric to the fleece.

### Example 3

In this Example, a styrene/butadiene latex foam was used as a backing for the point-bonded nonwoven fabric. A foam emulsion was poured onto a surface of the nonwoven fabric prepared above and then cured to give a foam-backed fabric.

### Example 4

In this Example, an 100% polyester fleece was used as a backing for the point-bonded nonwoven fabric. The fleece had an area weight of about 500 grams/meter² and had a thickness of about 1.5 millimeter. The fleece was bonded to the nonwoven fabric prepared above using a styrene acrylate latex adhesive.

Test Methods

(1) Vetterman Drum Test for Wear-Resistance

Carpet appearance retention may be measured by subjecting a carpet to a specified number of human traffics and visually determining a rating based on the degree of matting. Wear tests which closely correlate to floor trafficking were conducted in a Vetterman drum test apparatus, Type KSG manufactured by Schoenberg & Co. (BaLunbero, Fed. Rep. Of Germany), according to ISO (International Standards Organization) document TC38/12/WG 6 N 48. As specified, the drum is lined with test samples into which is placed a 7.3 kilogram (16 pound) steel ball having 14 rubber buffers which rolls randomly inside the rotating drum. The test sample is mounted in such a way that the fabric surface stays in contact with the steel ball and the bottom cushion layer stays against the drum. A circular brush within the drum is in light contact with the fabric surface and removes loose pile fibers which are continuously removed by suction. After 5000 and 20000 cycles, the samples are removed and inspected to evaluate appearance retention. Appearance retention is reported on a scale of 1-5 with a rating of 5 corresponding to an untested control sample, 4 corresponding to a lightly worn sample, 3 to a moderately worn sample, a rating of 2 corresponding to clearly unacceptable wear, and 1 corresponding to an extremely matted control sample. A rating of 2.5 serves as the transition point from acceptable to unacceptable wear.

(2) Castor Chair Test

Carpet appearance retention is also tested in a castor chair test. In the castor chair test, the effect of the continuous rolling action of castor wheels on the test sample is measured. Three castor wheels are placed on a test sample under load of 90 kilograms. The castor wheels are then wheeled in a circle, changing direction periodically. After 5000 and 25000 circles, the samples are removed and inspected to evaluate appearance retention. Appearance retention is reported on a scale of 1-5, the ratings being similar to those described hereinabove for the Vetterman drum test.

(3) Antistatic Test

The difference in electrical potential, in relation to the earth's potential (zero), produced by a person walking on a floor covering under test with standardized footwear in a prescribed manner and under controlled atmospheric conditions is measured. The results are used to evaluate the risk of a person experiencing the discomfort of static electrical shock. The test is performed in accordance with ISO standard DIS 6356. A rubber mat is placed on a grounded metal base plate and the floor covering under test placed on the rubber mat. The operative then walks on the floor covering in standardized sandals, the operative and the sandals being earthed immediately prior to the test. The operative holds a hand-held voltage measuring system and the maximum voltage is recorded during the test. The atmospheric humidity is also recorded.

Results

The floor coverings described in Examples 1-4 were tested using the Vetterman drum and 20 castor chair tests. Table 1 shows how the floor coverings performed in these tests.

TABLE 1

| | Vetterman Drum | | Castor Chair | |
|---|---|---|---|---|
| Example No. | 5000 cycles | 22000 cycles | 5000 cycles | 25000 cycles |
| 1 | 4.5 | 3.5 | not tested | not tested |
| 2 | 4.0 | 3.0 | 4.5 | 4.0 |
| 3 | 5.0 | 5.0 | 4.5 | 4.0 |
| 4 | 4.0 | 3.5 | 4.5 | 3.5 |

Table 1 shows that the point-bonded nonwoven floor coverings of the present invention have excellent appearance retention and wear-resistance. All samples tested had a rating of 3 or higher in the relevant tests, even after 22000 or 25000 cycles.

In addition, all Examples tested had good edge-fray resistance and performed well in the Lisson Tretad test for abrasion resistance.

Table 2 shows a comparison of the point-bonded nonwoven fabric of the present invention with the prior art area-bonded nonwoven fabric. Neither of the materials had a backing layer.

TABLE 2

| | Vetterman Drum | Castor Chair | |
|---|---|---|---|
| Preparation No. | 5000 cycles | 5000 cycles | 25000 cycles |
| 1 (point-bonded) | 3.0 | 4.0 | 3.0 |
| 2 (area-bonded) | 2.5 | 2.0 | 1.5 |

The results from the Vetterman drum and castor chair tests in Table 2 demonstrate the superiority of point-bonded nonwoven fabrics compared with area-bonded nonwoven fabrics for use in floor coverings. Hence, it is clear that the nonwoven floor coverings of the present invention are superior to the nonwoven floor coverings known in the prior art.

Non-woven materials prepared from monocomponent fibers are also suitable for use in the present invention. Accordingly, monocomponent materials were prepared by a procedure similar to that described above in Preparation 1, using nylon 6 fibers. It was found that these monocomponent materials performed comparably to bicomponent materials in the relevant tests for abrasion and wear resistance.

Antistatic Floor Coverings

### Example 5

### Antistatic Fabric

An antistatic point-bonded nonwoven fabric was prepared following the procedure in Preparation 1. However, 400 parts per million by weight of the fibers were conductive fibers. The conductive fibers were bicomponent fibers of nylon 6,6 and nylon 6, with the nylon 6 component containing 30% by weight of a carbon black additive.

In the following Examples, various combinations of a plain or conductive point-bonded nonwoven fabrics with a plain or conductive hot melt polymer were tested. In all these Examples, the fleece backing layer contained no antistatic additives.

### Example 6

### Plain Fabric; Antistatic Hot Melt Polymer

Example 1 was repeated using a sytrene-butadiene hot melt polymer containing 3% by weight of a conductive additive. The conductive additive was CONPOL EP 4 16, available from DuPont.

### Example 7

### Plain Fabric; Antistatic Hot Melt Polymer

Example 7 was repeated using 6% by weight of conductive additive in the hot melt polymer.

### Example 8

### Antistatic Fabric; Plain Hot Melt Polymer

Example 1 was repeated using the antistatic point-bonded nonwoven fabric described Example 5.

### Example 9

### Antistatic Fabric; Antistatic Hot Melt Polymer

Example 8 was repeated using the hot melt polymer (containing 3% conductive additive) described in Example 6.

### Example 10

### Antistatic Fabric; Antistatic Hot Melt Polymer

Example 8 was repeated using the hot melt polymer (containing 6% conductive additive) described in Example 7.

Examples 1 and 6-10 were tested for their antistatic properties. A body voltage of about 2000 Volts is the threshold where most people would not be able to feel a static shock. The results are shown in Table 3.

TABLE 3

| Example No. | Body Voltage @ 25% humidity |
|---|---|
| 1 | 5000 |
| 6 | 2100 |
| 7 | 2000 |
| 8 | 1650 |
| 9 | 850 |
| 10 | 1150 |

Example 1, having no antistatic additives in either the fabric layer or the hot melt polymer, performs relatively poorly in the antistatic test. Examples 6 and 7, having a conductive additive in the hot melt polymer, perform better than Example 1. However, a person would probably still be able to feel a small shock with these floor coverings. Examples 8-10, having a conductive fabric layer, perform excellently in the antistatic test.

It will, of course, be understood that the present invention has been described by way of example, and that modifications of detail can be made within the scope of the invention.

1. A floor covering of a non-woven upper fabric layer and at least one backing layer wherein said non-woven fabric layer is a point-bonded fabric layer.

2. A floor covering according to claim 1 wherein the point-bonded fabric layer is produced by a process comprising the steps of:
(a) providing a fibrous web of synthetic fibers;
(b) needle-punching said fibrous web to provide a needle-punched material; and
(c) point-bonding said needle-punched material.

3. A floor covering according to claim 1 wherein the upper layer is affixed to the backing layer by an ethylene copolymer adhesive consisting essentially of from 50 to 95 weight % ethylene and 5 to 50 weight % of one or more comonomers selected from the group consisting of vinyl esters, α,β unsaturated carboxylic acids, α,β unsaturated carboxylic acid esters, and mixtures thereof.

4. A floor covering according to claim 1 wherein a surface selected from the top surface, the bottom surface, or the top and bottom surface of the upper fabric layer is coated with a polymeric coating.

5. A floor covering according to claim 1 wherein the upper fabric layer has an area weight of from 60 to 300 grams/meter².

6. A floor covering according to claim 1 wherein the upper fabric layer has a thickness of from 0.2 to 2.0 millimeters.

7. A floor covering according to claim 1 wherein the fibers of non-woven material are bicomponent fibers.

8. A floor covering according to claim 7 wherein the bicomponent fiber is a polymeric core-sheath fiber.

9. A floor covering according to claim 8 wherein the core polymer is nylon 6,6 and the sheath polymer is nylon 6.

10. An antistatic floor covering according to claim 1 wherein the fabric layer is conductive.

11. A conductive point-bonded non-woven fabric suitable for use in antistatic floor coverings.

12. A non-woven fabric according to claim 11 comprising bicomponent fibers as defined in claims 8 or 9 and additional conductive fibers.

13. A non-woven fabric according to claim 12 wherein the conductive fibers are bicomponent fibers comprising a conductive additive.

14. A non-woven fabric according to claim 13 wherein the conductive additive is carbon black.

15. Use of a point-bonded non-woven fabric as defined in claim 1 or claim 2 in the manufacture of a floor covering.

16. A method of producing a floor covering according claim 1 comprising the steps of providing a point-bonded non-woven fabric as defined in claim 1 or claim 2 and affixing said non-woven fabric to at least one backing layer.

17. The method of claim 16, wherein said at least one backing layer is affixed to said non-woven fabric by extruding a molten thermoplastic polymer adhesive layer onto both the underside of the nonwoven fabric and one side of the backing layer at substantially the same time as said nonwoven fabric and backing layer enter a nip, said thermoplastic polymer adhesive layer comprising an ethylene copolymer of from 50 to 95 weight % ethylene and 5 to 50 weight % of one or more comonomers selected from the group consisting of vinyl esters, α,β unsaturated carboxylic acids, α,β unsaturated carboxylic acid esters, and mixtures thereof, and then compressing said nonwoven upper fabric layer, said molten polymer adhesive layer, and said backing layer in said nip.
